(19) United States
(12) Patent Application Publication
(10) Pub. No.: US 2009/0265859 A1
(43) Pub. Date: Oct. 29, 2009

(54) LETTER OPENER-CLIP UNIT

(76) Inventor: Dilip Bhavnani, Beverly Hills, CA (US)

Correspondence Address: THE SONI LAW FIRM, 35 North Lake Ave., Suite 720, PASADENA, CA, 91101, US

(21) Appl. No.: 12/108,475

(22) Filed: Apr. 23, 2008

(51) Int. Cl. B26B 11/00; B43K 29/00

(52) U.S. Cl. 7/160; 401/195; 401/292

(57) ABSTRACT

A letter opener-clip unit for use with an elongated handheld instrument. The generally elongated clip defines thereon an elongated and substantially U-shaped groove along a longitudinal symmetry axis thereof for accepting paper therein for cut. The groove is open at a first clip end where the clip is attached to the instrument and closed at a point on the clip proximate a second clip end to divide the clip into two branches separated by the groove. In the preferred embodiment, a pair of triangular shaped cutting members are opposingly disposed on the respective branches adjacent the first clip end, partly protruding into the groove to form a wedge at which the paper is cut as it moves within the groove from the second clip end toward the first clip end.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to field of a clip for use on an elongated handheld implement such as a writing instrument, that incorporates therein a letter opener.

Following background information is provided for better presenting the novelty and advantages of the present invention, and thus, not to be taken in any way as admission of prior art.

A letter opener is one of the most widely used desktop office items. Usually, the letter opener is made as a separate piece having an elongated configuration with a cutting blade. As such, it is designed for use mostly indoor, not outdoor, being kept either on an office desk or in a drawer thereof. There are, however, occasions in which a letter opener is needed while one is away from office. The conventional letter openers described above are somewhat bulky or otherwise inconvenient for one to carry with one's self.

Therefore, it would be best convenient and useful if such a letter opener can be incorporated with some portable articles that people ordinarily carry with their selves wherever they go. Writing instruments such as pens, pencils, or markers are such portable articles. If the letter opener is incorporated into those writing instruments, particularly into pocket clips that most writing instruments have, a user may enjoy the dual utilities whenever they are needed, even at outdoor. Further, for such a clip and letter opener combo unit, it would be desirable that the letter opener, usually including a sharp cutting member, is designed to neither injure a user nor damage the fabric of pockets when clipped therein.

There are a few inventions that disclose a writing instrument with a clip and a letter opener combination. For instance, U.S. Patent Application No. 2006/0193677 discloses a pen having a clip where a letter opening blade is located under the clip. For protection of pockets, the blade is mechanically connected to a plunger such that it extends out of a cavity located at an innermost region under the clip only when a writing tip of the instrument is protracted by pressing the plunger. This invention, however, is costly in manufacturing due to the relatively complicated structure required for the mechanical connection between the blade and the plunger.

U.S. Patent Application No. 2005/0196223 discloses similarly structured pen clip and letter opener combo unit. But this invention requires an additional structure, such as a stopper, for protection of a pocket against a blade of the letter opener when the pen is clipped therein, where the stopper, formed in front of the blade located at an innermost region under the clip, blocks the fabric of a pocket from contacting the blade.

U.S. Patent Application No. 2006/0140704 discloses a pen with a clip and letter opener combo unit having a U-shaped leaf with two arms resiliently disposed between one end of the clip and the pen body where the cutting blade is located at the tip of one of the arms for cutting paper inserted in the U-shaped leaf. This invention requires, however, continuous pressing down the clip, and the leaf thereunder, during the cutting. And further, the clip-letter opener unit in this invention is not structured to be easily detachable from the pen for a separate use.

U.S. Pat. No. 6,846,123 discloses a clip-letter opener unit where a paper-accepting channel is formed upon the clip and a cutting member is position at a closed end of the channel. The channel in this invention is defined, however, not along the longitudinal symmetry axis of the clip, but at an angle with respect thereto. This particular design, employed not to damage a pocket when the pen is clipped thereinto, is not aesthetically appeasing.

In light of those inventions described above, it is desirable to provide a clip and a letter opener combo unit which has a structure that is simple enough to reduce production cost, yet efficient to require only minimal force from a user in cutting paper, easily detachable from and re-attachable to a writing instrument as needed, and still aesthetically looking in overall design.

### SUMMARY OF THE INVENTION

In accordance with a preferred embodiment of the present invention, there is provided a clip-letter opener unit for use with an elongated handheld instrument.

The generally elongated clip has a first end at which the clip is removably attached to the handheld instrument such as a writing instrument and an opposing second end. The clip defines thereon an elongated and substantially U-shaped groove along the longitudinal symmetry axis thereof for accepting paper thereinto for cut. The groove is open at the first end of the clip and closed at a point on the clip proximate a second end to divide the clip into two symmetric branches separated by the groove.

In the preferred embodiment, a pair of identical triangular-shaped cutting members are opposingly disposed on branches adjacent the first clip end, partly embedded into the respective side inner surfaces of the branches, and partly protruding into the groove to form a wedge therein.

Such a wedge operates as a point of shear at which a piece of paper is cut as it moves within the groove from the second clip end toward the first clip end.

The clip is spaced apart, at a substantially equal distance, from the instrument to form an elongated gap under the groove so that the portion of the paper to be cut off may pass therethrough.

The clip may be integrally formed with an instrument cap via two props respectively extending from two branches to the cap where the instrument cap may be easily removable from the instrument so as to use the unit separately as a letter opener.

### BRIEF DESCRIPTION OF THE DRAWINGS

FIG. 1 illustrates a perspective view of a handheld instrument with a clip-letter opener unit made in the first preferred embodiment of the present invention;

FIG. 2 illustrates a side elevational view of a handheld instrument with a clip-letter opener unit made according to the present invention;

FIG. 3 illustrates a top plan view of a handheld instrument with a clip-letter opener unit made in the first preferred embodiment of the present invention;

FIG. 4 illustrates a rear perspective view of a handheld instrument with a clip-letter opener unit made in the first preferred embodiment of the present invention;

FIG. 5 illustrates a side elevational view of a handheld instrument with a clip-letter opener unit, which is being used in the exemplary manner contemplated by the present invention;

FIG. 6 illustrates a top plan view of a handheld instrument with a clip-letter opener unit made in the second preferred embodiment of the present invention;

FIG. 7 illustrates a rear cross-sectional view of a clip-letter opener unit made in the second preferred embodiment of the present invention; and

FIGS. 8A and 8B illustrate a top plan and side cross-sectional views, respectively, of cutting members to be incorporated in a clip-letter opener unit made in the second preferred embodiment of the present invention.

### DETAILED DESCRIPTION OF THE PREFERRED EMBODIMENT

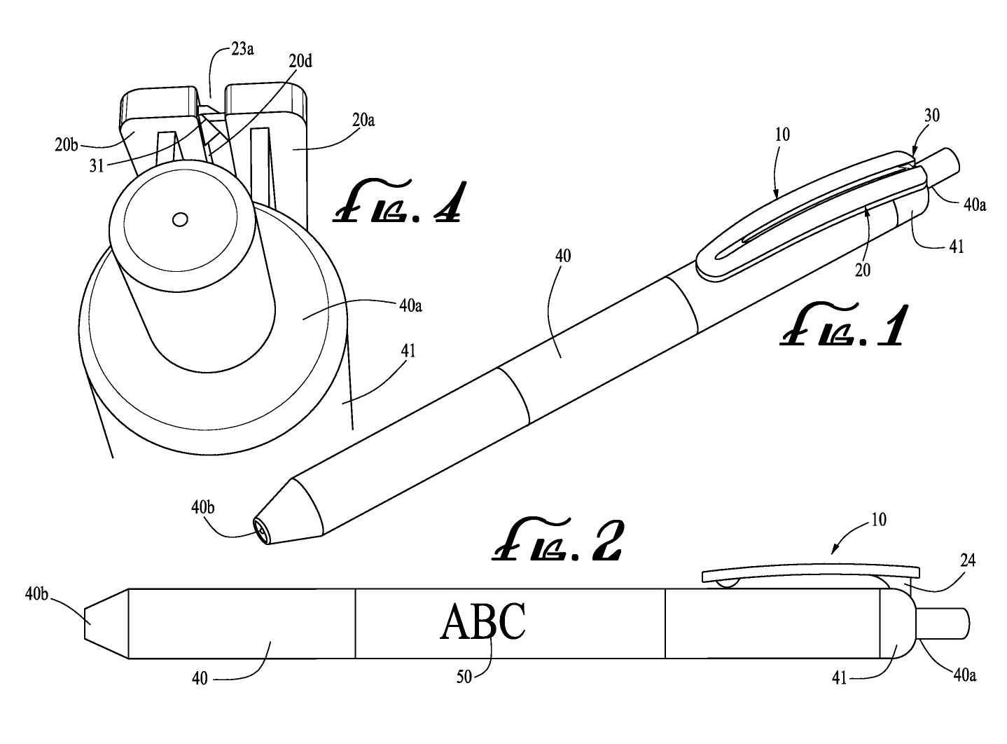

Referring now to the drawings wherein the showings are for purposes of illustrating preferred embodiments of the present invention only, and not for purposes of limiting the same, in FIGS. 1-8, the preferred embodiment of the clip-letter opener unit 10 for use with an elongated handheld instrument comprises largely a generally elongated clip body 20 having first clip end 21 and opposing second clip end 22 and a longitudinal axis of symmetry A extending between the clip ends, and a letter opener 30 incorporated into the clip body 20.

The clip body 20 defines an elongated central groove 23 of a substantially equal width thereon along the longitudinal axis of symmetry A, thereby dividing the clip body 20 into two symmetric identical branches 20a and 20b. In the preferred embodiment, the groove 23 has an elongated U-shape, which is open at the first clip end 21, defining thereat an open grove end 23a, and closed substantially proximate the second clip end 22, defining thereat a closed grove end 23b. The groove 23 operates as guiding duct for a piece of paper to be cut by the letter opener 30.

For the letter opener 30, FIGS. 1-8 show, among other embodiments, two preferred embodiments contemplated by the present invention. In both of the preferred embodiments, the letter opener 30 comprises at least one cutting member attached to one or both of the branches 20a and 20b of the clip body 20. The at least one cutting member is positioned and configured such that it cuts paper inserted into the groove 23 as the paper moves substantially along the longitudinal axis of symmetry A in a direction from the closed groove end 23b toward the open groove end 23a. The at least one cutting member in both of the preferred embodiments is, more particularly, a pair of identical cutters 31 located proximate the open groove end 23, each of which is shaped as a right-angled isosceles triangle and having a blade 31a formed on its longest side.

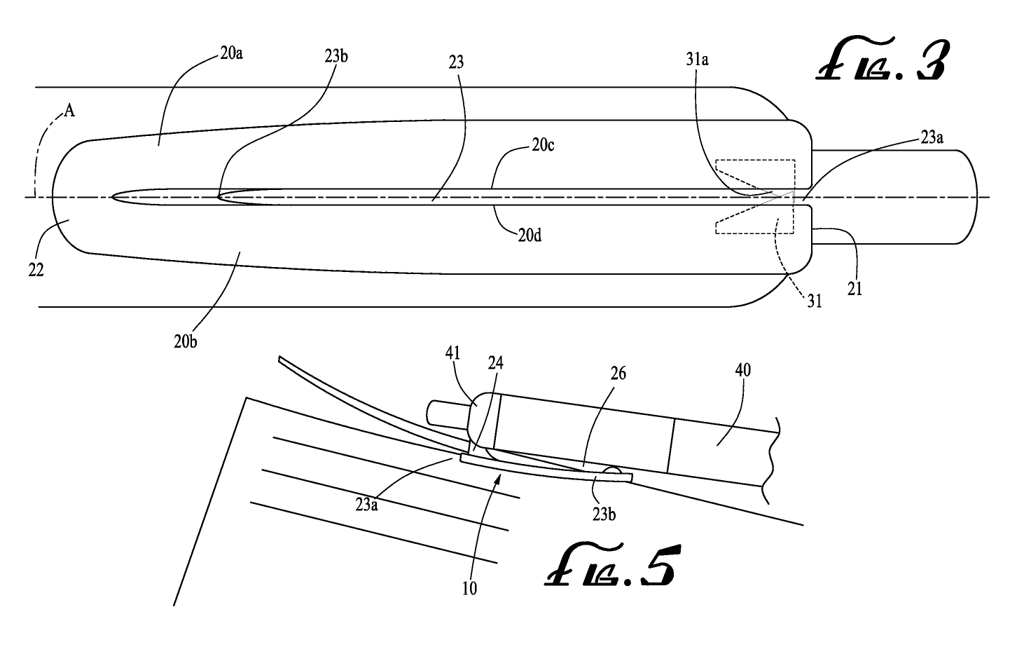

The two preferred embodiments differ in the specific way the cutters 31 are disposed with respect to the branches 20a and 20b. In the first preferred embodiment, illustrated in FIGS. 1, 3, and 4, an end portion of each of the cutters 31 is securably embedded into the respective inner groove surfaces 20c or 20d of the respective branches 20a or 20b, as shown in dotted line in FIG. 3. For accommodating the end portions of the cutters 31 within the respective inner groove surfaces 20c and 20d, a slot(not shown) may be defined on the respective surfaces 20c and 20d. For that, the branches 20a and 20b of the clip body 20 are arranged to have a sufficient thickness. The embedding and securing of the end portions of the cutters 31 into the respective inner groove surfaces 20c and 20d may be accomplished by any attachment or fixation method known to a person of ordinary skill in the art, and thus, such method will not be described herein further. In embedding the cutters 31, one of two right-angled sides of each cutter 31 is oriented to be parallel to the longitudinal axis of symmetry A. With such orientation, the two cutters 31 symmetrically face each other across the groove 23, with each exposing the rest of its body including part of the respective blades 31a within the groove 23 as shown in FIGS. 3 and 4. The two exposed blade portions are configured to symmetrically cross each other, one at the top and the other at the bottom, to form a V-shaped wedge within the groove 23. Such a wedge operates as a point of shear at which a piece of paper engaged thereto is cut.

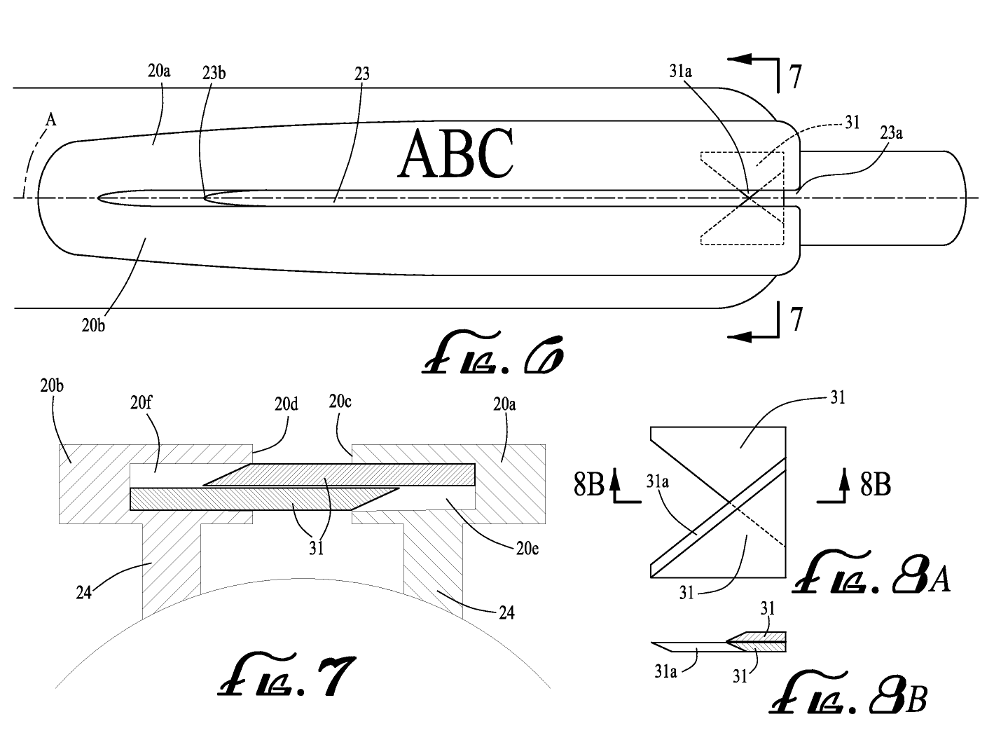

In the second preferred embodiment, depicted in FIGS. 6-8, the cutters 31 are, as in the first preferred embodiment, symmetrically opposing each other across the groove 23 with an end portion of respective cutters 31 being securably embedded into the respective inner groove surfaces 20c or 20d. The difference is that in the second embodiment, the other end portion of each cutter 31 opposite to the embedded portion is also embedded into the opposite respective inner groove surfaces 20c or 20d as shown in FIGS. 6 and 7. For that, as shown in FIG. 7, a slot 20e and 20f may be defined on the respective surfaces 20c and 20d as the first preferred embodiment, but this time slightly bigger than the slot in the first preferred embodiment for accommodating two cutters 31. For each cutter 31, a middle portion of the blade 31a becomes exposed within the groove 23, and those two exposed middle portions symmetrically cross each other, one at the top and the other at the bottom, to form a V-shaped wedge within the groove 23 as shown in FIG. 6. As similar to the first preferred embodiment, such a wedge operates as a point of shear at which a piece of paper engaged thereto is cut.

FIG. 5 shows how the letter opener 30 in the present invention is used to cut a piece of paper or a letter envelope. A user holds the clip-letter opener unit with one hand and inserts a piece of paper into the groove 23 with the other hand until the portion of the paper that is to be cut engages the V-shaped wedge. A slight push of the paper toward the open groove end 23a will initiate the cut at the V-shaped wedge, the point of shear. A slightly inward squeeze of the end portions of two branches where the cutters 31 are disposed would further facilitate the cut by creating a scissor effect between the two opposing blades 31a. As the paper continues to be pulled along the groove 23 toward the open groove end 23a, it would be cut in a smooth, steady fashion as shown in FIG. 5.

The particular cutting mechanism in the preferred embodiment described above, which employs two identical triangular cutters, is merely one of many embodiments of the cutting mechanism contemplated by the present invention which utilizes the U-shaped central elongated groove defined on the clip body. For instance, in another embodiment (not shown), the letter opener may employ only a single cutting member that is partially disposed into one of the branches of the clip. Or in other embodiments, the clip-letter opener unit may use any other cutting mechanism well known to a person of ordinary skill in the art. As long as the cutting mechanism has at least one cutting member disposed in one or both of the branches, and such cutting member is configured to cut paper inserted within the groove as the paper moves substantially along the longitudinal axis of symmetry in a direction from the closed groove end 23b toward the open groove end 23a, then such cutting mechanism falls within the contemplation of the present invention.

Further, in the preferred embodiment, for facilitating the seamless cutting of paper, the clip body 20 is spaced apart, at a substantially equal distance, from the pen 40 to form a straight gap 26 under the groove 23 so that, as shown in FIG. 5, the portion of the paper that is to be cut may be guided through the gap.

In the present invention, the clip-letter opener unit 10 is contemplated to be used either as a separate letter opener or as being attached to an elongated handheld instrument. In the preferred embodiment described in FIGS. 1-6, the clip-letter opener unit 10 is parallelly attached a handheld instrument, which is a writing instrument, a typical ball point pen 40. However, all other kinds of writing instruments and even non-writing elongated handheld instruments are also contemplated for use with the clip-letter opener unit in the present invention. Those non-writing instruments may include, but are not limited to, a PDA stylus, an input pen, a screwdriver, a laser pointer, or a doctor's searching light.

For attaching to the pen 40, the clip-letter opener unit 10 further has, in the preferred embodiment, two props 24 perpendicularly extending respectively from the two branches 20a and 20b near the first clip end 21, which are connected to the pen 40 near, preferably, an end 40a where a plunger is located, opposing the tip end 40b from which a ball pen tip may retractably protrude. The internal mechanism of a typical ball point pen including the ink cartridge and the retractable pen tip is well known in the art and will not be described further herein.

So as to have the clip-letter opener unit 10 detachable from the pen 40 for use as a separate letter opener, in the preferred embodiment, the two props 24 are connected, preferably integrally formed, with a removable pen cap 41 rotatably attached to the plunger end 40a. However, in another embodiment (not shown), the clip-letter opener unit may be made detachable from the pen via any other detaching mechanism that is well known in the art. For instance, the two props may be integrally connected with a circular ring or band (not shown) sheathed around the pen near the plunger end, which can be easily slid off the pen body for using the clip-letter opener unit as a separate letter opener. In still another embodiment (not shown), the clip-letter opener unit may be, although less preferable, permanently attached to or integrally formed with the pen body, either via the two props or directly.

The clip body 20 is preferably manufactured from plastic. But any other suitable rigid materials recognized by one skilled in the art, such as metal, wood, or ceramic materials, may be used. Also, the cutters 31 may be integrally formed with the blades 31a, and fabricated of a same material such as plastic. But the blades 31a may be fabricated of different material, which could be any rigid materials recognized by one skilled in the art as suitable for cutting a piece of paper.

Since the handheld instrument with the clip-letter opener unit would be more likely to attract attentions of the user and other viewers owing to its unique design and utility, it can be an effective vehicle for advertisement. For that advertising material 50 may be imprinted on any of outer surface of the implement, including but not limited to, the outer surface of the pen 40 as shown in FIG. 2, or the surface(s) of one or both of the clip branches 20a and 20b as shown in FIG. 6. Such advertising material may include, but not be limited to a logo, trademark, advertisement, emblem, label, stamp, feature, brand, insignia, crest, token, seal, decal, pitch, announcement, slogan, monogram. Such indicia need not be limited to letters or words, but can be also a photo, design, or other pictorial representation.

Accordingly, the present invention also includes a method of advertising using the handheld instrument with the clip-letter opener unit made according to the invention. Such an advertising method comprises the steps of providing a desktop organizer made according to the present invention, and disposing advertising indicia on an external visible surface of the handheld instrument. The term “providing” has a broad meaning, including not only manufacturing but also acquiring from another source or selecting from available supplies. The term “disposing” is meant broadly to encompass any means for physically putting the advertising indicia on the surface, including but not limited to, imprinting, engraving, adhering, etc.

The present invention is capable of other and different embodiments, and its several details are capable of modifications in various respects apparent to those of ordinary skill in the art, all without departing from the essential spirit or attributes of the invention. Therefore, it is desired that the embodiments described hereinbefore be considered in all respects only as illustrative, but not as restrictive.

1. A clip-letter opener unit for use with a handheld instrument, the unit comprising:
a generally elongated clip body having opposing first and second clip ends and a longitudinal axis of symmetry extending therebetween, the clip body defining an elongated, substantially U-shaped groove thereon along the longitudinal axis of symmetry, thereby dividing the clip body into two symmetric branches, the groove having an open groove end at the first clip end and a closed groove end at a point on the clip body substantially proximate the second clip end; and
at least one cutting member disposed on at least one of the branches proximate the first clip end, wherein the at least one cutting member is configured to cut paper inserted into the groove as the paper moves substantially along the longitudinal axis of symmetry in a direction from the closed groove end toward the open groove end.

2. The clip-letter opener unit as in claim 1, wherein the at least one cutting member consists of two substantially identical opposing cutting members, respectively disposed symmetrically on the respective branches proximate the first clip end.

3. The clip-letter opener unit as in claim 2, wherein each of the branches has an inner groove surface, the two inner groove surfaces facing each other across the groove, and a portion of each of the cutting members is embedded into the respective inner groove surfaces.

4. The clip-letter opener unit as in claim 3, wherein each of the two opposing cutting members has a substantially triangular configuration, and a portion of the respective cutting members is exposed within the groove such that the exposed portions form a wedge with an open end thereof directed toward the closed groove end, whereby the wedge operates as a point of shear in paper cutting.

5. A handheld instrument comprising:
an elongated instrument body;
a generally elongated clip having opposing first and second clip ends and a longitudinal axis of symmetry extending therebetween, the clip being connected, at the first clip end, to the elongated instrument body substantially parallelly, the clip defines an elongated, substantially U-shaped groove thereon along the longitudinal axis of symmetry, thereby dividing the clip into two symmetric branches, the groove having an open groove end at the first clip end and a closed groove end at a point on the clip substantially proximate the second clip end; and
at least one cutting member disposed on at least one of the branches proximate the first clip end, wherein the at least one cutting member is configured to cut paper inserted into the groove as the paper moves substantially along the longitudinal axis of symmetry in a direction from the closed groove end toward the open groove end.

6. The handheld instrument as in claim 5, wherein the at least one cutting member consists of two substantially identical opposing cutting members, respectively disposed on the respective branches proximate the first clip end.

7. The handheld instrument as in claim 6, wherein each of the branches has an inner groove surface, the two inner groove surfaces facing each other across the groove, and a portion of each of the cutting members is embedded into the respective inner groove surfaces.

8. The handheld instrument as in claim 7, wherein each of the two opposing cutting members has a substantially triangular configuration and a portion of the respective cutting members is exposed within the groove such that the exposed portions form a wedge with an open end thereof directed toward the closed groove end, whereby the wedge operates as a point of shear in paper cutting.

9. The handheld instrument as in claim 5, wherein the entire portion of the groove is at a substantially equal distance from the instrument body to form an elongated gap therebetween for guiding therethrough a portion of the paper that is to be cut by the at least one cutting member.

10. The handheld instrument as in claim 9, wherein the clip further comprises two connecting props respectively extending substantially perpendicularly from a portion of respective branches proximate the open groove end to the instrument body.

11. The handheld instrument as in claim 5, wherein the handheld instrument is a writing instrument.

12. The handheld instrument as in claim 5, further comprising advertising material disposed on an outer surface of the handheld implement.

13. The handheld instrument as in claim 5, wherein the clip is detachable from the instrument body so as to be utilized as a letter opener separate from the implement.

14. A method of advertising comprising the steps of:
a) providing a handheld instrument comprising:
1) an elongated instrument body,
2) a generally elongated clip having opposing first and second clip ends and a longitudinal axis of symmetry extending therebetween, the clip being connected, at the first clip end, to the elongated instrument body substantially parallelly, the clip defines an elongated, substantially U-shaped groove thereon along the longitudinal axis of symmetry, thereby dividing the clip into two symmetric branches, the groove having an open groove end at the first clip end and a closed groove end at a point on the clip substantially proximate the second clip end, and
3) at least one cutting member disposed on at least one of the branches proximate the first clip end, wherein the at least one cutting member is configured to cut paper inserted into the groove as the paper moves substantially along the longitudinal axis of symmetry in a direction from the closed groove end toward the open groove end; and
b) disposing advertising material on an outer surface of the handheld implement.
